(19) United States
(12) Patent Application Publication
(10) Pub. No.: US 2010/0121770 A1
(43) Pub. Date: May 13, 2010

(54) SYSTEM AND METHOD FOR TRACKING SHIPS AND SHIP CARGO

(75) Inventor: Daniel T. Johnson, Medina, MN (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Verisae, Inc., Minneapolis, MN (US)

(21) Appl. No.: 12/253,024

(22) Filed: Oct. 16, 2008

Related U.S. Application Data
(63) Continuation of application No. 11/432,298, filed on May 11, 2006, now abandoned.
Application No. 11/432,298 is a continuation-in-part of application No. 10/768,957, filed on Jan. 30, 2004, now Pat. No. 7,062,389.
Application No. 10/768,957 is a continuation-in-part of application No. 09/883,779, filed on Jun. 18, 2001, now Pat. No. 7,496,532.
Application No. 09/883,779 is a continuation-in-part of application No. 10/429,619, filed on May 5, 2003, now Pat. No. 7,512,523.
Application No. 10/429,619 is a continuation-in-part of application No. 10/734,725, filed on Dec. 12, 2003, now abandoned.
Application No. 10/734,725 is a continuation-in-part of application No. 10/771,090, filed on Feb. 3, 2004, now abandoned.
Application No. 10/771,090 is a continuation-in-part of application No. 10/922,364, filed on Aug. 20, 2004, now abandoned.
(60) Provisional application No. 60/679,761, filed on May 11, 2005.
(60) Provisional application No. 60/444,091, filed on Jan. 31, 2003.
(60) Provisional application No. 60/212,234, filed on Jun. 16, 2000.
(60) Provisional application No. 60/288,827, filed on May 5, 2001.
(60) Provisional application No. 60/432,120, filed on Dec. 9, 2002.
(60) Provisional application No. 60/433,179, filed on Dec. 13, 2002.
(60) Provisional application No. 60/444,437, filed on Feb. 3, 2003.
(60) Provisional application No. 60/496,432, filed on Aug. 20, 2003.

(51) Int. Cl. G06Q 50/00; G06Q 10/00; G01C 21/00; G06F 17/30

(52) U.S. Cl. 705/333; 701/300; 701/207; 707/802; 707/758; 707/E17.014; 707/E17.044

(57) ABSTRACT

The subject invention relates to systems and methods of tracking ships and ship cargo. In one embodiment, the system includes a central processor, a position tracking system, and a database. According to one aspect of the invention, the methods includes registering, tracking, and confirming the arrival of a plurality of ships or ship containers.

### CROSS-REFERENCE TO RELATED APPLICATION

This application is a continuation of U.S. patent application Ser. No. 11/432,298, filed May 11, 2006, entitled “System and Method for Tracking Ships and Ship Cargo,” which claims priority to U.S. Patent Application No. 60/679,761, filed May 11, 2005, entitled “System and Method for Tracking Ships and Ship Cargo,” the contents of both of which are hereby incorporated herein by reference in their entireties. This application also is a continuation-in-part of U.S. patent application Ser. No. 10/768,957, entitled “Enterprise Energy Management System,” filed Jan. 30, 2004, and issued as U.S. Pat. No. 7,062,389 on Jun. 13, 2006, which claims priority to U.S. Patent Application No. 60/444,091, filed Jan. 31, 2003, entitled “Enterprise Energy Management System,” and which is a continuation-in-part of U.S. patent application Ser. No. 09/883,779, filed Jun. 18, 2001, entitled “Enterprise Asset Management System and Method,” which claims priority to both U.S. Patent Application No. 60/212,234, filed Jun. 16, 2000, entitled “Method and System for Managing Enterprise Assets,” and U.S. Patent Application No. 60/288,827, filed May 5, 2001, entitled “Enterprise Asset Management System and Method,” the contents of all of which are hereby incorporated herein by reference in their entireties. The application is also a continuation-in-part of U.S. patent application Ser. No. 10/429,619, filed May 5, 2003, entitled “Refrigerant Loss Tracking and Repair,” which claims priority to U.S. Patent Application No. 60/432,120, entitled “Refrigerant Loss Tracking and Repair,” filed Dec. 9, 2002, the contents of both of which are hereby incorporated herein by reference in their entireties. In addition, the application is a continuation-in-part of U.S. patent application Ser. No. 10/734,725, entitled “Notification System,” filed Dec. 12, 2003, which claims priority to U.S. Patent Application No. 60/433,179, filed Dec. 13, 2002, entitled “Notification System,” and the present application is a continuation-in-part of U.S. patent application Ser. No. 10/771,090, filed Feb. 3, 2004, entitled “Site Equipment Survey Tool,” which claims priority to U.S. Patent Application No. 60/444,437, entitled “Site Equipment Survey Tool,” filed Feb. 3, 2003, the contents of all of which are hereby incorporated herein by reference in their entireties. In addition, the application is a continuation-in-part of U.S. patent application Ser. No. 10/922,364, entitled “Electronic Payment System,” filed Aug. 20, 2004, which claims priority to U.S. Patent Application No. 60/496,432, entitled “Electronic Payment System,” filed Aug. 20, 2003, the contents of both of which are hereby incorporated herein by reference in their entireties.

### FIELD OF THE INVENTION

The present invention relates to tracking of ships and ship cargo and also to increasing security of ports.

### BACKGROUND OF THE INVENTION

In the new environment created by terrorism, it is clear that the United States of America may be attacked at any time and in any way. One method of transporting a weapon of mass destruction into the United States is by using any ship or container that approaches or penetrates our borders. Presently, the contents of less than 2% of all ocean-going container ships are examined for security purposes.

Given that government resources are not unlimited, simply increasing the present security system for examination of ships and ship containers would mean an exorbitant increase in expenditures that will never be approved.

Thus, there is a need in the art for an inexpensive method for tracking ships and ship cargo.

### BRIEF SUMMARY OF THE INVENTION

The present invention, according to one embodiment, is a system for tracking a container. The system includes a central processor, a position tracking system, and a database. The position tracking system is configured to track a position of the container and is in communication with the central processor. The database is configured to store tracking information for the container and is in communication with the central processor. The central processor is configured to process information from the position tracking system and the database. According to one alternative embodiment, the system also includes an asset tracking system configured to receive container information, the asset tracking system being in communication with the central processor.

According to another embodiment, the subject invention is a method of tracking a plurality of containers. The method includes registering each of the containers, tracking each of the containers in transit, and confirming arrival of the containers at a destination.

In another embodiment, the present invention is a method of tracking a plurality of ships. The method includes examining and certifying each of the plurality of ships at a point of origin. It further includes tracking the plurality of ships in transit between the point of origin and a destination. Further, it includes confirming arrival of each of the plurality of ships at the destination.

While several embodiments are disclosed, still other embodiments of the subject invention will become apparent to those skilled in the art from the following detailed description, wherein is shown and described only the embodiments of the invention, by way of illustration, of the best modes contemplated for carrying out the invention. As will be realized, the invention is capable of modifications in various obvious aspects, all without departing from the spirit and scope of the subject invention. Accordingly, the drawings and detailed description are to be regarded as illustrative in nature and not restrictive.

### BRIEF DESCRIPTION OF THE DRAWINGS

FIG. 1 is a block diagram depicting schematically the various components of a cargo and ship tracking system, according to one embodiment of the present invention.

FIG. 2 is a flow diagram of a method of tracking a container or ship, according to one embodiment of the present invention.

FIG. 3 is a flow diagram of a process for registering a container or ship, according to one embodiment of the present invention.

### DETAILED DESCRIPTION

The present invention relates to a system and method for tracking ships and ship cargo, including, for example, container ships or ship containers. In one aspect of the invention, the tracking system can increase the security of ports and reduce the risk of ship- or ship container-borne threats such as terrorist threats.

Generally, the system and method of the present invention relates to registration (examination and certification) of a ship container or a ship and all its containers at the origination port, tracking of the ship or container in transit, and confirmation of the arrival of the registered container or ship at the destination port. Thus, the system allows for not only efficient tracking of ships and containers, but also provides for examination and certification for security purposes of any container or ship at the outgoing port, thereby reducing time and expense required for security checks at the destination port and resulting in greater safety for the destination port city and country. Thus, the present invention can improve the efficiency and reduce the burden of inbound container inspection by automating most inspections and allowing security to focus on exception management.

“Ship” as used herein shall mean any vessel for travel or transport of any type of cargo on water.

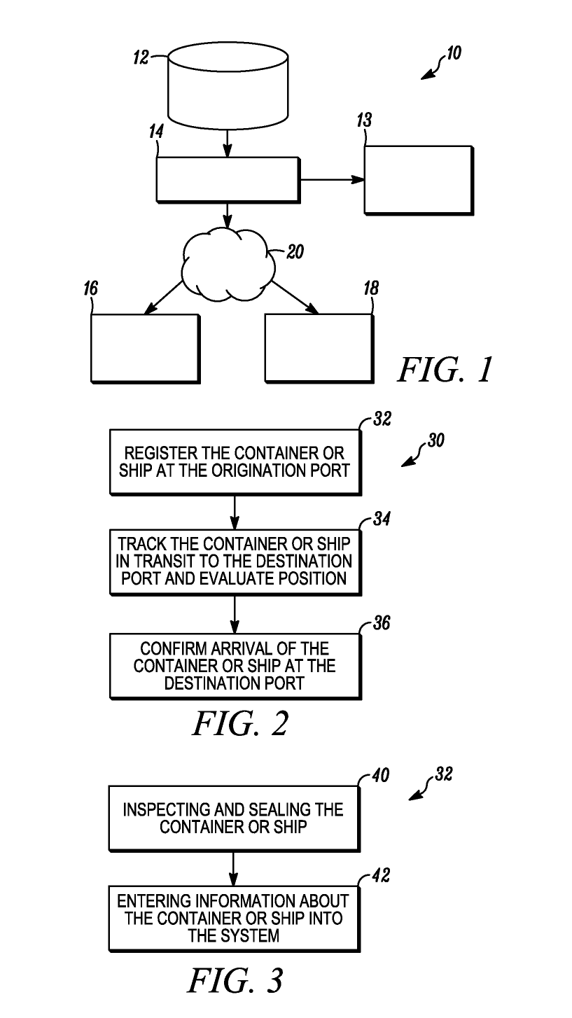

As depicted in FIG. 1, the system and method of tracking ships and ship cargo 10, according to one embodiment, generally includes, but is not limited to, the following components: a database 12, a central processor 14, a global position tracking system 16, and an asset tracking system 18, wherein the position tracking system 14 and the asset tracking system 16 are connected or operably coupled to the processor 14 over a network 20. According to one embodiment, the network 20 is the Internet 20. Alternatively, either or both of the systems 16, 18 are connected or operably coupled to the processor 14 wirelessly.

Generally, the overall structure and operation of the system is similar to and operates under the same general principles as that disclosed in U.S. application Ser. No. 09/883,779, entitled “Method and System for Managing Enterprise Assets” and filed on Jun. 18, 2001, which is hereby incorporated by reference in its entirety. The central processor 14 includes software programs or instructions that run on the server-side to process requests and responses from a client processor 13. These software programs or instructions send information to the client processor 13, perform compilation and storage functions, generate reports that may be used by either the clients or the headquarters of the enterprise, or carry out asset management functions. The software may be software applications commercially sold and normally used by those skilled in the art or they may be specific applications coded in a standard programming language. Further details of the functions performed by the software are provided below.

The central processor 14 can be any processor known in the art. In addition, the central processor 14 according to one embodiment is intended to mean any computer known in the art, including standard attachments and components thereof (e.g., a disk drive, hard drive, CD player or network server that communicates with a CPU and main memory, a sound board, a keyboard and mouse, and a monitor). The processor of the CPU in the computer may be any conventional general-purpose single- or multi-chip microprocessor. In addition, the processor may be any conventional special purpose processor such as a digital signal processor or a graphics processor. The microprocessor has conventional address lines, conventional data lines, and one or more conventional control lines. In one embodiment, the central processor 14 includes a website hosted in at least one or more computer servers. These servers may comprise web servers, database servers and/or application servers, and they run on a variety of platforms, including UNIX machines, Windows 2000, Windows NT, and Macintosh.

The central processor 14 includes software programs or instructions that operate to process information from the position tracking system 16, the asset tracking system 18, and/or the database 12. These software programs or instructions can receive or exchange information with the position tracking system 16 or the asset tracking system 18, carry out container or ship tracking functions, utilize the database 12 to perform compilation and storage functions, generate reports that may be used by either the clients or the headquarters of the enterprise, or functions. Alternatively, either or both of the position tracking system 16 and the asset tracking system 18 can be integral with the central processor 14, such that certain software programs or instructions integral with the processor 14 perform the functions of either or both systems 16, 18. The software may be software applications commercially sold and normally used by those skilled in the art or they may be specific applications coded in a standard programming language. Further details of the functions performed by the software are provided below. According to one embodiment, the central processor 14 has geographic information systems (“GIS”) software and/or global positioning system (“GPS”) software that can operate within the system 10 to assist with tracking a container or ship.

The database 12, in one aspect of the invention, is a database for storing tracking information relating to the container or ship. The database 12 may be of any type generally known in the art. In one embodiment, the database 12 is configured to retain information relating to any container arriving by ship at any port in a particular country. In one example, the database 12 is a large secure Oracle.™. database. In one embodiment, a scaleable database (e.g., Oracle) is used to allow for expansion as the amount of information tracked increases.

The database 12 is accessible to the central processor 14 through a computer network or other suitable communication link. Alternatively, the database 12 can be integral to the central processor 14. The database 12 server can be operated by the system proprietor, and/or may include an external database or databases operated by a remote entity that is accessible through a computer network. In a further alternative, the database 12 is comprised of a plurality of database servers, some of which are integral to the central processor 14, and some that are located remotely from the central processor 14.

The global position tracking system 14 operates within the system of the present invention 10 to provide for monitoring or tracking the position of the container or ship of interest, according to one embodiment of the present invention. According to one embodiment, the tracking system 14 is a satellite-based tracking system that automatically tracks the location and ID of a ship on a real time basis. That is, a transponder associated with the ship transmit identification information that is received by a satellite and processed to determine the location of the ship. For example, the tracking system 14 can operate using GPS technology or a similar technology. Alternatively, the global position tracking system 14 can be any known system for monitoring the geographical position of a mobile item of interest.

The asset tracking system 18, in accordance with one aspect, provides for identifying and tracking the location of a container or ship and providing that information for use within the system of the present invention 10. According to one embodiment, the system 18 utilizes radio frequency identification (“RFID”) technology to “tag” or uniquely identify any container or ship and thereby track that container or ship to its destination. In one aspect of the present invention, the system 18 also allows for associating information about the container or ship, including, for example, its contents, with the unique identification for that container or ship.

FIG. 2 depicts the system and method of the present invention in operation 30, in accordance with one aspect of the invention. Generally, the operation of the system 30 includes registering the container or ship at the origination port (block 32), tracking the container or ship in transit to the destination port and evaluating the position of the container or ship (block 34), and confirming the arrival of the container or ship at the destination port (block 36).

In one aspect of the present invention, a ship and all its containers are registered and tracked. Alternatively, a ship, but not its containers, is registered and tracked. In a further alternative, one or more containers, but not the ship, are registered and tracked.

The process of registering the container or ship at the origination port 32, which is depicted in FIG. 3, allows for information about the container or ship to be entered into the system 10. The registering process 32 can include inspecting the container or ship and thereafter sealing the inspected container or some portion of the inspected ship (block 40) and entering information about the container or ship into the asset tracking system 18 (block 42). In one aspect of the invention, the registration process occurs at the origination port. Alternatively, the registration process can occur at any point along the trip between the origination and destination ports. In a further alternative, the registration process can occur before or after the ship is hauling cargo from one location to another.

For registration of a ship and all its containers 32, the inspection and seal step can include examining or inspecting each container and the ship for the presence of any threat. The threat can be a weapon of mass destruction, such as a nuclear weapon, a dirty bomb, a chemical weapon, a biological weapon, or any other known weapon of terrorism. Alternatively, the threat could be any known weapon or dangerous material. In a further alternative, the inspection could relate to any known inspection that can be performed on cargo, such as a quality inspection or any other known type of inspection.

The method of inspection or examination, of course, relates to the goal of the inspection or examination. If the goal is to identify any nuclear weapon or dirty bomb on a ship or in a container, the inspection method is a scan for radiation. This can be performed by any known method for identifying the presence of radiation. Alternatively, if the goal is to identify another type of weapon, the appropriate detection equipment and methods are applied to the task. In a further alternative, if the goal is to perform another type of inspection, the appropriate known method can be used.

After passing inspection, each container can be sealed, according to one embodiment. Alternatively, portions of the ship, such as certain cargo holds that have passed inspection, can be sealed. Thus, when the container or ship arrives at the destination port, a simple sight inspection can show whether the container or portion of the ship has been entered or “compromised” since the inspection at the origination port.

For registration of a container 32, the step of gathering and entering information 40 can include entering container information into the asset tracking system 18 relating to, for example, contents, inspection data, destination, expected arrival date, itinerary. The inspection data can include, but are not limited to, the inspection performed, the results, and information about the inspector.

According to one embodiment, a read/write RFID tag is attached to each container at the origination port and the information is written to the tag. In one embodiment, the information is written to the tag prior to attachment. Alternatively, it can be written to the tag after attachment. Alternatively, the information can be entered into the system 10 such that it is provided directly to the central processor 14.

For registration of a ship 32, the step of gathering and entering information 40 can include entering information about each container on the ship, which might include all the container information, and might further include entering information regarding the origination port, ship registry and ownership information, departure date, intermediate port information, destination port, and arrival date. According to one embodiment, the central processor 14 can process this information using, for example, the GIS software, to create a projected “itinerary” for the ship and its cargo.

According to one embodiment, the container information or ship information or both can be gathered using a handheld computer using methods and systems similar to those disclosed in U.S. application Ser. No. 10/771,090, filed on Feb. 3, 2004 and entitled “Site Equipment Survey Tool,” which is incorporated herein by reference in its entirety. The data can then be transferred via a secure link to the asset tracking system 18 or the central processor 14 where the container and ship information can be linked such that it is possible to determine which containers are on which ship. The linked information can then be loaded into the database 12 for tracking.

The container survey software would allow the container to be “cubed” which would allow better management of incoming containers.

After the container or ship has left the origination port, the container or ship can be tracked 34 using the global position tracking system 16. The tracking system 16 can identify the location of the container or ship and provide that information to the central processor 14. According to one embodiment, the central processor 14 can then compare the location information provided by the tracking system 16 with the itinerary information provided by the asset tracking system 18 to determine whether there is any difference between the two and identify any container or ship that is not traveling its planned course. That is, the system 10 provides for “exception management” relating to any inbound ships.

In a further embodiment, a ship-based system could track the location and condition of each container and subsequently make that information available via a ship-based transponder to the position tracking system 16. For example, the RFID tag attached to each container could be configured to track the condition of the seal applied to the container after inspection. Thus, if the seal is broken, that information could be provided to the RFID tag, which could then provide that information to an RFID-based receiver that could then transmit that information to the position tracking system 16 via the ship transponder.

According to one embodiment, the system 10 of the present invention can confirm arrival of the container or ship at the destination port 36. The position tracking system 14 can provide position information to the central processor 14 relating to the container or ship being in a particular port, and the central processor 14 can then compare that position information to the itinerary information previously collected and added to the database 12. Alternatively, the asset tracking system 18 can be used to confirm arrival of the container or ship.

In accordance with one aspect of the invention, one entity or organization could oversee the system 10 of the present invention and thereby track and manage the movement of ships into and out of a country. For example, in the United States, an existing federal department such as the Department of Homeland Security or a new federal department could perform this function.

Alternatively, the system 10 of the present invention could also be used for a non-security purpose such as serving as an information resource for customers such as shipping companies, etc. to better track their ships and cargo. Further, the system 10 can be used to track not just cargo ships, but any type of ship. In a further alternative, this system 10 could be used with other modes of cargo transport, including domestic transportation of freight, such as trains, etc.

In one aspect of the present invention, the entire system 10 could be financed by charging a container fee or inspection fee of some kind to the ship company or another company associated with the containers or cargo.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

Although the present invention has been described with reference to preferred embodiments, persons skilled in the art will recognize that changes may be made in form and detail without departing from the spirit and scope of the invention.

What is claimed is:

1. A method of certifying and tracking a plurality of ships and a plurality of containers on each of the plurality of ships, the method comprising:
registering each of the plurality of ships at its origination port and each of the plurality of containers on each of the plurality of ships, the registering comprising:
inspecting at least a portion of each of the plurality of ships;
sealing the inspected portion of each of the plurality of ships;
certifying each of the inspected ships;
inspecting each of the plurality of containers on each of the plurality of ships;
sealing the inspected containers; and
certifying each of the examined containers;
entering registration information relating to the registering of each of the plurality of ships and plurality of containers into a shipping management and tracking system, wherein the entering information does not require radio frequency communication;
automatically creating with the shipping management and tracking system a projected itinerary for each of the plurality of ships based on the registration information;
tracking with the shipping management and tracking system an actual location of each of the plurality of ships after each of the plurality of ships departs from its origination port;
comparing the actual location of each of the plurality of ships with its projected itinerary; and
automatically identifying any ship that is deviating from its projected itinerary.

2. The method of claim 15, wherein the registration information for each of the plurality of ships comprises information about each container on the ship, origination port information, ship registry and ownership information, departure date, intermediate port information, destination port information, and arrival date information.

3. The method of claim 15, further comprising tracking an actual location of each of a plurality of containers on one of the plurality of ships by tracking the actual location of the ship.

4. The method of claim 15, further comprising automatically confirming arrival of each of the plurality of ships at its destination port.

5. The method of claim 15, wherein the registration information for each of the plurality of containers comprises container contents information, container inspection information, container destination information, expected container arrival date information, and container itinerary information.

6. The method of claim 19, wherein the inspection information comprises inspection type information, inspection results information, and inspector information.

7. A network-based management system for managing and tracking a plurality of ships and a plurality of containers on each of the plurality of ships, the system comprising:
(a) a central processor accessible on a computer network;
(b) a database in communication with the central processor, the database configured to store:
(i) ship information comprising information about each container on the ship, ship origination port information, ship registry and ownership information, ship departure date, ship intermediate port information, ship destination port information, and ship arrival date information; and
(ii) container information comprising container contents information, container inspection information, container destination information, expected container arrival date information, and container itinerary information;
(c) itinerary software configured to automatically create a projected itinerary for a ship based on the ship information; and
(d) tracking software configured to:
(i) track an actual location of the ship and provide that information to the central processor;
(ii) compare the actual location of the ship with the projected itinerary of the ship; and
(iii) automatically identify any deviation of the ship from its projected itinerary,
wherein the system does not require radio frequency identification tags.

8. The system of claim 21, further comprising a client processor in communication with the central processor through the computer network, wherein the client processor inputs, queries, and downloads ship and container information from the system.

9. The system of claim 21, wherein at least a portion of the ship information is collected during an inspection and certification of the ship.

10. The system of claim 21, wherein at least a portion of the container information is collected during an inspection and certification of the container.

11. The system of claim 21, wherein the tracking software is further configured to track an actual location of each of the plurality of containers on the ship by tracking the actual location of the ship and provide that information to the central processor

12. The system of claim 21, wherein the tracking software is further configured to automatically confirm arrival of the ship at its destination port.

13. The system of claim 21, wherein the container inspection information comprises inspection type information, inspection results information, and inspector information.

14. A network-based management system for managing and tracking a plurality of ships and a plurality of containers on each of the plurality of ships, the system comprising:
(a) a central processor accessible on a computer network;
(b) a database in communication with the central processor, the database configured to store:
(i) ship information comprising information about each container on the ship, ship origination port information, ship registry and ownership information, ship departure date, ship intermediate port information, ship destination port information, and ship arrival date information; and
(ii) container information comprising container contents information, container inspection information, container destination information, expected container arrival date information, and container itinerary information;
(c) itinerary software configured to automatically create a projected itinerary for a ship based on the ship information; and
(d) tracking software configured to:
(i) track an actual location of the ship and provide that information to the central processor;
(ii) compare the actual location of the ship with the projected itinerary of the ship; and
(iii) automatically identify any deviation of the ship from its projected itinerary.

15. The system of claim 28, further comprising a client processor in communication with the central processor through the computer network, wherein the client processor inputs, queries, and downloads ship and container information from the system.

16. The system of claim 28, wherein at least a portion of the ship information is collected during an inspection and certification of the ship.

17. The system of claim 28, wherein at least a portion of the container information is collected during an inspection and certification of the container.

18. The system of claim 28, wherein the tracking software is further configured to track an actual location of each of the plurality of containers on the ship by tracking the actual location of the ship and provide that information to the central processor

19. The system of claim 28, wherein the tracking software is further configured to automatically confirm arrival of the ship at its destination port.

20. The system of claim 28, wherein the container inspection information comprises inspection type information, inspection results information, and inspector information.
